(19) United States
(12) Patent Application Publication
(10) Pub. No.: US 2004/0176072 A1
(43) Pub. Date: Sep. 9, 2004

(54) Simplified handling of, blocking of, and credit for undesired messaging

(76) Inventor: Randall C. Gellens, San Diego, CA (US)

Correspondence Address: Qualcomm Incorporated, Patents Department, 5775 Morehouse Drive, San Diego, CA, 92121-1714, US

(21) Appl. No.: 10/356,115

(22) Filed: Jan. 31, 2003

(51) Int. Cl. H04M 3/42; H04M 11/10

(52) U.S. Cl. 455/412.1; 455/414.1

(57) ABSTRACT

Systems and methods for dynamic server-based filtering that selectively deletes or delivers received messages or summary information therefor, based upon the characteristics of the received messages and the filtering rules implemented by the server. In one embodiment, a server receives electronic messages addressed to a client and applies a set of filtering rules to the messages to categorize them into groups of wanted, unwanted, and preview messages. Wanted messages are delivered in their entirety without further input. Unwanted messages are deleted without further input. Summary information is delivered for preview messages. A user provides feedback indicating that the corresponding message should be delivered in its entirety, or deleted. The deliver or delete decision can be applied to one message, or to all similar messages. The server takes action according to the feedback, updates its filtering rules and credits the user's account, as appropriate.

### BACKGROUND OF THE INVENTION

The invention relates generally to the field of telecommunications, and more particularly to systems and methods for improving the handling of electronic messages with respect to filtering and delivery of messages in accordance with user preferences.

Personal computers are becoming ubiquitous. They are being used by increasing numbers of people, ranging from scientists and engineers to students and even children. They are almost as common in the home as they are at work. With the increasing use of computers, it is also becoming increasingly common for people to have access to the Internet. People can use these tools to surf the World Wide Web, to retrieve information and to communicate, among other things.

One of the most common uses of computers and the Internet is for people to communicate with each other. Probably the most common means of communication is e-mail, or electronic messaging. A person can easily obtain an e-mail account through his Internet service provider, or through one of the many e-mail services that are available on the Web (e.g. Hotmail). The availability of email has also made it a popular medium for advertising and for broadcasting information to large numbers of recipients.

Originally, most people made use of e-mail from their desktop personal computers. In other words, they would sit at their computers, log into their e-mail accounts and then read received e-mails or send e-mails to others. Because of its popularity, however, e-mail service has been extended to smaller, portable devices. For example, e-mail services are available through wireless-enabled personal digital assistants (PDAs), cell phones and other, similar devices.

One of the problems that arises from the use of portable, handheld devices to access e-mail service is that this access has to be provided using far fewer resources than are available in any desktop computing environment. For instance, there are severe constraints on memory, processing power, user interface capabilities and so on. While these constraints certainly have not affected the popularity of e-mail services in the wireless handheld environment, they have caused a premium to be placed on the way certain issues are handled in order to provide the best service.

One of the important issues to be addressed in the wireless handheld environment relates to the volume of messages that are communicated to an e-mail client. These messages may include e-mails which are expected, or are from known senders, and which the recipient wishes to be delivered immediately. The messages may also include e-mails that contain advertising or other unwanted matter, and that the recipient does not wish to have delivered at all. These latter messages are commonly referred to as “spam”. The messages may also include e-mails of an [intermediate] nature, which the recipient may or may not wish to have delivered.

The volume of messages that may be delivered to a recipient is important because, as noted above, a handheld device may have severely limited memory and processing capabilities (as compared to a desktop environment). It may therefore be difficult for the device to process or store a large volume of messages. Further, it is often the case that a client is charged for delivery of messages in a wireless environment, so a large volume of messages may result in a large expense for delivery of the messages. For these and various other reasons, it would be beneficial to provide a means for controlling the delivery of messages so that neither the clients resources, nor the recipient's pocketbook are unduly taxed by the delivery of unwanted messages.

### SUMMARY OF THE INVENTION

One or more of the problems outlined above may be solved by the various embodiments of the invention. Broadly speaking, the invention comprises systems and methods for improving electronic message delivery systems by implementing dynamic server-based filtering that selectively delivers part or all of the information of received messages, based upon the characteristics of the received messages and the filtering rules implemented by the server. The systems and methods may also include a mechanism for automatically crediting a user's account for delivery of unwanted messages.

In one embodiment, a server is configured to receive electronic messages addressed to a particular client and to filter the received messages based upon a set of filtering rules. The messages are categorized into one of three groups: wanted messages; unwanted messages; and messages that are not known to fall into either of the first two groups. Wanted messages are delivered in their entirety without further input. Unwanted messages, such as spam, are deleted without further input. The remaining messages are delivered in summary form, pending feedback from the recipient. When summary information is received, a user reviews the information and determines whether he or she wishes to have the message delivered in its entirety, or to have the message deleted. This feedback is provided to the server, which then takes the appropriate action. The decision to deliver or delete the message corresponding to the summary information may also be applied to similar messages that are received by the server in the future. If similar future messages are to be handled in the same way (i.e., delivered in their entireties or deleted), the user indicates this in the feedback and provides the server with an indication of how “similar” messages are to be identified (e.g., by identical senders or subjects). Upon receipt of this information, the server updates the filtering rules accordingly and uses these rules to filter any future messages. In one embodiment, when feedback is received from the user indicating that all future similar messages are to be deleted without being delivered, the server is configured to generate a billing record crediting the user's account for any charges associated with the unwanted (deleted) message.

In one embodiment, a method comprises receiving a plurality of messages, identifying a first subset of the received messages, and for each message in the first subset, generating summary information, providing the summary information to a client, receiving feedback responsive to the summary information, and handling the message in accordance with the feedback. The feedback in this embodiment may comprise an indication that a particular message should be delivered in its entirety or deleted without being delivered, or that the message and all future messages that are similar should be handled in one of these ways. The basis for determining which future messages are similar is also provided in the feedback.

In one embodiment, a system comprises a server and a client coupled to the server, wherein the server is configured to receive electronic messages addressed to the client, apply dynamic filtering rules to the electronic messages, transmit a summary information for a first subset of the filtered messages to the client, receive feedback from the client responsive to the summary information and deliver or delete messages in the first subset according to the feedback. In this embodiment, the server is configured to modify the filtering rules based on the feedback, and is further configured to generate billing/credit records that are communicated to a billing system that is coupled to the server. The server may comprise a multimedia messaging relay/server, and the client may comprise a multimedia messaging user agent. The client and server may be configured to communication via a limited-bandwidth communication link, such as a wireless communication link.

Another embodiment of the invention comprises a software application. The software application is embodied in a computer-readable medium such as a floppy disk, CD-ROM, DVD-ROM, RAM, ROM, database schemas and the like. The computer readable medium contains instructions which are configured to cause a computer to execute a method which is generally as described above. It should be noted that the computer readable medium may comprise a RAM or other memory which forms part of a computer system. The computer system would thereby be enabled to perform a method in accordance with the present disclosure and is believed to be within the scope of the appended claims.

Numerous additional embodiments are also possible.

### BRIEF DESCRIPTION OF THE DRAWINGS

Various aspects and features of the invention are disclosed by the following detailed description and the references to the accompanying drawings, wherein:

FIG. 1 is a diagram illustrating a wireless communication system in accordance with one embodiment of the invention;

FIG. 2 is a functional block diagram illustrating the structure of a wireless transceiver in accordance with one embodiment;

FIG. 3 is a diagram illustrating the filtering and delivery of e-mail messages which are addressed to a particular recipient in accordance with one embodiment;

FIG. 4 is a diagram illustrating the communications between an e-mail server and an e-mail client in regard to preview messages in accordance with one embodiment;

FIG. 5 is a diagram illustrating the processing of received messages by a server and the forwarding of the messages or summary information, as appropriate, to a client in accordance with one embodiment;

FIG. 6 is a diagram illustrating the receipt of summary information by a client and the generation of responsive feedback for transmission to a server in accordance with one embodiment;

FIG. 7 is a diagram illustrating the receipt of a user's feedback by a server and the actions taken by the server in response to the feedback in accordance with one embodiment;

FIG. 8 is a diagram illustrating a generalized view of the Multimedia Messaging Service architecture;

FIG. 9 is a diagram illustrating the components of the MMS architecture in accordance with one embodiment; and

FIG. 10 is a diagram illustrating the protocol framework definition in accordance with a Wireless Application Protocol (WAP)-based embodiment of the present invention.

While the invention is subject to various modifications and alternative forms, specific embodiments thereof are shown by way of example in the drawings and the accompanying detailed description. It should be understood, however, that the drawings and detailed description are not intended to limit the invention to the particular embodiments which are described.

### DETAILED DESCRIPTION OF A PREFERRED EMBODIMENT

One or more preferred embodiments of the invention are described below. It should be noted that this and any other embodiments described below are exemplary and are intended to be illustrative of the invention rather than limiting.

As described herein, various embodiments of the invention comprise systems and methods for improving electronic message delivery systems by implementing dynamic server-based filtering that selectively delivers part or all of the information of received messages, based upon the characteristics of the received messages and the filtering rules implemented by the server, then receives feedback from a user and uses this feedback to handle the received messages and, if necessary, to update the filtering rules.

In one embodiment, a server is configured to receive electronic messages addressed to a particular client and to filter the received messages based upon a set of filtering rules. The messages are categorized into one of three groups: wanted messages; unwanted messages; and messages that are not known to fall into either of the first two groups. Wanted messages are delivered in their entirety without further input. Unwanted messages, such as spam, are deleted without further input. The remaining messages are delivered in summary form, pending feedback from the recipient.

In this embodiment, the recipient receives the wanted messages in their entirety. The unwanted messages are deleted before ever being delivered, so the recipient never sees them. The recipient also never has to pay for their delivery or storage. When the recipient receives summary information for a message from the third group, he replies to the server, indicating either that the message should be delivered or that it should be deleted. If the recipient elects to have the message delivered, the user can indicate that all similar messages should be delivered, or simply that the one message should be delivered without affecting future messages. If the recipient elects to have the message deleted, the user can indicate that all similar messages should be deleted, or simply that the one message should be deleted without affecting future messages. If the message is delivered or deleted without affecting future messages, the filtering rules used by the server are unaffected. If the recipient elects to have all similar messages delivered or deleted, the filtering rules used by the server are updated to reflect this election.

In one embodiment, a recipient response that a message and all similar messages should be deleted is tied to a credit mechanism. Recipients typically do not want to receive certain messages (e.g., spam), and do not wish to pay for delivery of these messages. Conventionally, these messages are delivered to the recipients, who then have to delete the messages and contact their service providers to have their accounts credited. In the present system, the crediting of a recipient's account occurs automatically when the recipient identifies the message as unwanted and causes it to be deleted. It should be noted that the credit mechanism in this embodiment is tied to the non-delivery/deletion of all similar messages in order to provide assurance for the service provider that the credit is justified.

As noted above, the problem of handling large volumes of email is particularly important in the context of portable handheld devices such as cell phones. Accordingly, one embodiment of the present invention is implemented in a wireless communication system.

The various embodiments of the present invention may provide a number of advantages over existing systems and methods. For example, by filtering messages at the server instead of the client, a substantial burden is removed from the client, which may have very limited processing and storage resources. Filtering the messages at the server may also reduce the bandwidth usage required to transmit messages to the client, as it may entirely eliminate transmission of unwanted messages, and for messages that fall into the preview category, the amount of data transmitted for the client to preview may be substantially less than the amount of data in the whole message. Still further, because filters do not need to be transmitted from the client to the server, a substantial savings of the bandwidth from the client to the server may be realized. Still further, the automatic crediting of the user's account for unwanted mail may relieve the user of the burden of contacting the service provider to get credit for delivery of unwanted messages (which may have to be repeated if future unwanted messages are delivered).

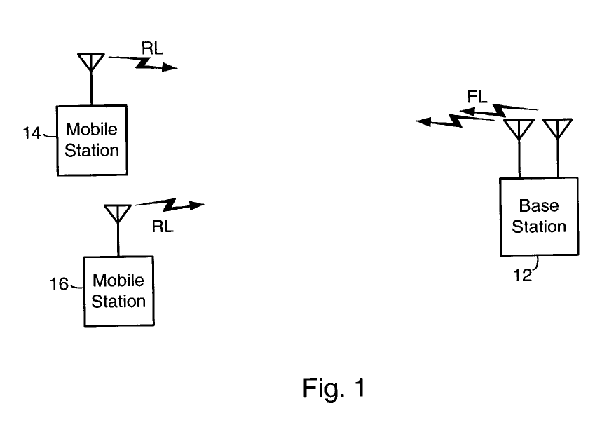

Referring to FIG. 1, a diagram illustrating a wireless communication system in accordance with one embodiment of the invention is shown. In this embodiment, a base station 12 is associated with a sector. The sector is simply an area of coverage of the base station. Within the sector are a plurality of mobile stations, two of which (14, 16) are illustrated in the figure. It should be noted that there may be more or fewer mobile stations in the sector associated with base station 12, and that the illustrated mobile stations are exemplary. Likewise, a particular mobile station may be within the sectors of multiple base stations, although this is not explicitly shown in the figure.

In the system of FIG. 1, base station 12 is configured to transmit data to each of mobile stations 12 and 14 via a forward link (FL). The forward link is simply a wireless communication channel from the base station to the mobile station. Each of mobile stations 14 and 16 is configured to transmit data back to the mobile station via a reverse link (RL.). As the mobile stations move, they may go from one sector to another, and the forward and reverse links may be broken and established between the various mobile stations and base stations as appropriate under the rules of the system.

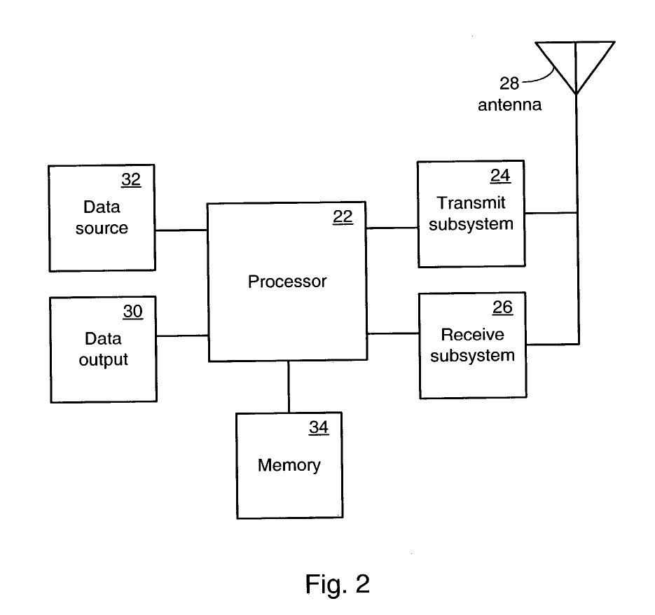

Referring to FIG. 2, a functional block diagram illustrating the structure of a wireless transceiver in accordance with one embodiment is shown. This transceiver is described somewhat generically because it is intended to exemplify the components of both a mobile station and a base station. While the requirements of mobile and base stations differ significantly, the respective requirements are addressed in the implementation details of each. At a very basic level, the components of the two devices are approximately the same.

As depicted in FIG. 2, the transceiver comprises a processor 22 coupled to a transmit subsystem 24 and a receive subsystem 26. Memory 34 is coupled to processor 22 for storage of data used by the processor. Transmit subsystem 24 and receive subsystem 26 are coupled to shared antenna 28. Processor 22 receives data from receive subsystem 26, processes the data, and outputs the processed data via output device 30 (e.g., a display of a mobile station or a server in a base station). Processor 22 also receives data from data source 32 (e.g., a keypad of the mobile station or an email server coupled to a base station) and processes the data for transmission. The processed data is then forwarded to transmit subsystem 24 for transmission over the wireless communication link. In addition to processing the data from receive subsystem 26 and data source 32, processor 22 is configured to control the various subsystems of the transceiver. In particular, the email client or server applications may run on processor 22. The functionality described below for the base station and mobile station are implemented in processor 22 of the respective devices.

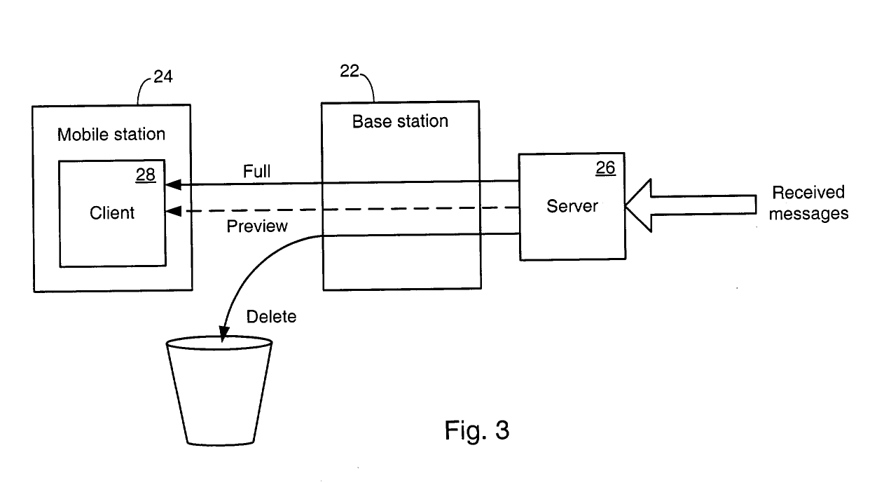

Referring to FIG. 3, a diagram illustrating the filtering and delivery of e-mail messages which are addressed to a particular recipient in accordance with one embodiment is shown. As depicted in this figure, e-mail messages that are addressed to a user associated with mobile station 24 are initially delivered to an e-mail server 26. E-mail server 26 is typically centralized within a carrier's network and serves multiple base stations. In this embodiment, messages are delivered by server 26 through base station 22 to mobile station 24. E-mail server 26 is configured to apply a set of filtering rules to the received e-mail messages and to handle these messages in accordance with the filtering rules.

In one embodiment, e-mail server 26 performs triage on the received e-mail messages. That is, the filtering process results in one of three actions by e-mail server 26. First, the message may be forwarded immediately, in its entirety, to an e-mail client 28 within mobile station 24. Second, summary or preview information corresponding to the message may be forwarded to e-mail client 28. Finally, the message may simply be deleted by e-mail server 26 without ever having delivered the message to e-mail client 28. For the purposes of this disclosure, messages that are immediately forwarded to e-mail client 28 are referred to as “wanted” messages. Messages for which summary information is transmitted to e-mail client 28 are referred to herein as “preview” messages. Messages that are deleted by e-mail server 26 without further inquiry are referred to herein as “unwanted” messages.

It should be noted that “immediately,” as used herein, means without first forwarding summary information and waiting for user feedback. Thus, a message that is forwarded at a time somewhat later than the message is received, or a message that is forwarded after a user okays the download of messages, but without forwarding summary information, is considered to have been immediately forwarded for the purposes of this disclosure. It should also be noted that a message is considered, for the purposes of this disclosure, to have been forwarded “in its entirety” if the substantive elements of the message are delivered, even if some of the elements are not forwarded. For example, if a message is forwarded without attachments, or if the message is forwarded in segments (e.g., if it is very large), or if the message is modified in some way (e.g., if it is reformatted), the message is nevertheless considered to have been forwarded in its entirety.

The first and last of these options (i.e., forwarding the message or deleting the message) are relatively straightforward. If the message is forwarded to e-mail client 28, the user will, in this embodiment, be billed for the delivery of the message and possibly storage of the message. If the message is deleted, it is never delivered to e-mail client 28. The user never sees the message, and is not billed for delivery or storage of the message. If, however, e-mail server 26 determines that summary information for the message should be delivered to e-mail client 28, e-mail server 26 still needs to determine what to do with the message. E-mail server 26 therefore waits for feedback from e-mail client 28 that will serve to instruct e-mail server 26 as to how the message should be handled (i.e., whether it should be forwarded to e-mail client 28 in its entirety, or deleted).

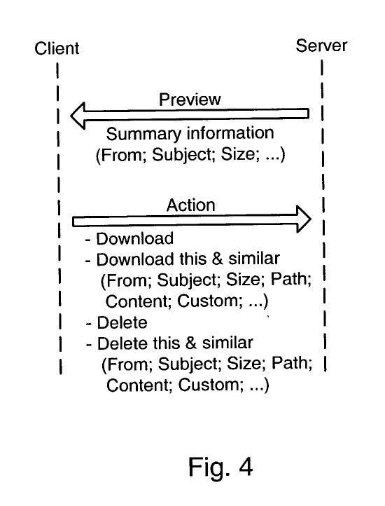

Referring to FIG. 4, a diagram illustrating the communications between e-mail server 26 and e-mail client 28 in regard to preview messages is shown. In this figure, e-mail server 26 is represented by the vertical line on the right side of the figure, while e-mail client 28 is represented by the vertical line on the left side of the figure. Thus, communications from e-mail server 26 to e-mail client 28 are represented by arrows that point from right to left, while communications from e-mail client 28 to e-mail server 26 are represented by arrows that point from left to right.

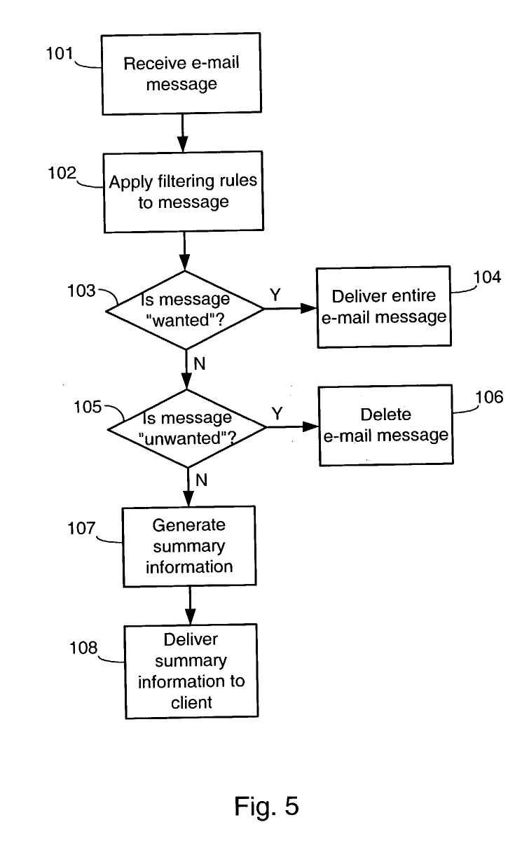

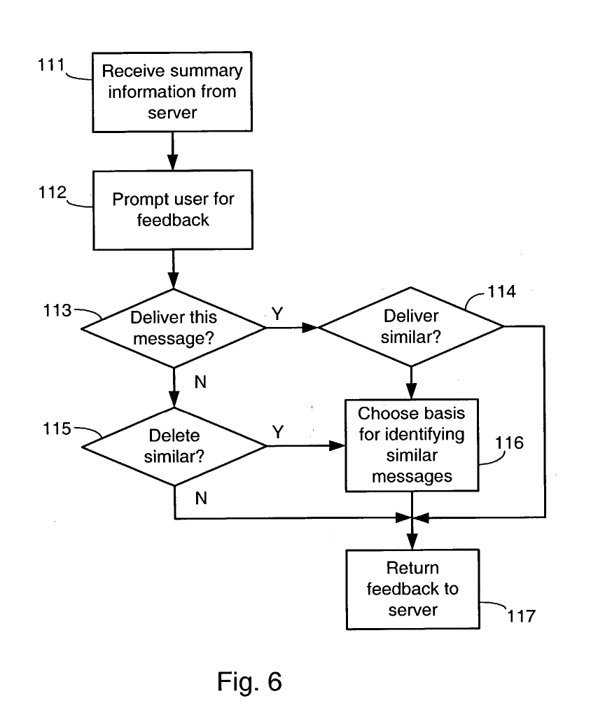

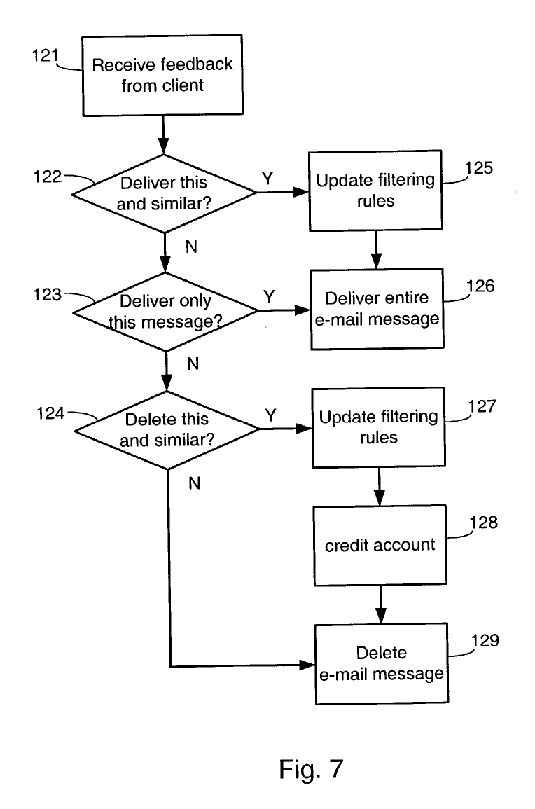

The processes involved in the operation of the system are summarized in the flow diagrams of FIGS. 5-7. FIG. 5 illustrates the processing of received messages by the server and the forwarding of the message or summary information, as appropriate, to the client. FIG. 6 illustrates the receipt of summary information by the client and the generation of responsive feedback for transmission to the server. FIG. 7 illustrates the receipt of the user's feedback by the server and the actions taken by the server in response to the feedback. The operation of the system will be described with reference to both the functional block diagram of FIG. 4 and the flow diagrams of FIGS. 5-7. The references to FIGS. 5-7 will be enclosed in parentheses.

It should be noted that the steps indicated in the figures are exemplary and, in other embodiments, may be combined or broken down into different steps, or may be performed concurrently. Some of these differences may be dependent upon the capabilities of the particular user interface with which the method is used. Other variations are also possible.

When an e-mail message is received by e-mail server 26 (block 101), the server's filtering rules are applied to the message (block 102). If the message is determined to be a “wanted” message (block 103), the message is delivered to the client (block 104). If the message is not a “wanted” message, the server determines whether the message is “unwanted” (block 105). If so, the message is deleted (block 106). If the message is neither “wanted” nor “unwanted,” it is a preview message, and e-mail server 26 generates summary information corresponding to the message (block 107). This summary information is then forwarded to e-mail client 28 (indicated in FIG. 4 by arrow 30) (block 108). The summary information may include various types of information corresponding to the message, such as the sender of the message, the subject line, or the size of the message. The particular summary information that is provided may vary from one embodiment to another.

When the summary information for the message is received by e-mail client 28 (block 111), it can be stored in much the same way a message that is delivered in its entirety is stored. When a user has an opportunity to review any received messages and/or summary information (“previews”), the summary information can be presented in the same manner as an ordinary received message. (In alternative embodiments, the summary information may be handled in a different manner than ordinary messages.) E-mail client 28 is configured, however, to not only present the summary information to the user, but also to prompt the user for feedback relating to the summary information (block 112). In other words, the user is allowed to review the summary information and then provide instructions as to the handling of the full message corresponding to the summary information.

In this embodiment, the user has four options for responding to the summary information for the preview message. Two of the options involve reading the message and two of the options involve deleting the message. Upon reading the summary information, the user decides whether he wishes to view the entire message (block 113). If he indicates that the message should be delivered, he must choose whether the message should be delivered without any affect on other messages, or whether other, similar messages should also be delivered (i.e., classified as wanted messages) (block 114). If only the previewed message is to be delivered, this feedback is delivered to the server (block 117). If similar messages are to be delivered, the user also provides an indication of the basis for determining which of the future messages are “similar” (block 116). For example, the user may indicate that all messages that are received from a particular sender, or including a particular subject should be classified as wanted messages and delivered without any further user feedback. This feedback is then transmitted to the server (block 117).

If, on the other hand, the user reviews the summary information and decides that he does not wish to view the entire message, he can indicate that the message should be deleted. Again, this may be done either with respect to the associated message alone, or with respect to the associated message and all future, similar messages (block 115). If the user chooses to delete only the message associated with the summary information, this feedback is transmitted to the server (block 117). Messages that are received by the server in the future will not be affected by the deletion of this message. If the user chooses to delete the associated message, as well as any similar, future messages, then the user also provides an indication of the basis for determining which of the future messages are “similar” (block 116). This feedback is then transmitted to the server (block 117). Similar messages will be deleted by the server when they are received, without ever delivering them to the client, or even providing summary information on them.

The server receives the feedback generated from the client (block 121) and determines (blocks 122-124) whether the message and/or similar messages should be delivered (block 126) or deleted (block 129). In the event that the user opts to have all “similar” messages either delivered or deleted, the e-mail server is configured to take this feedback and dynamically update the filtering rules that are implemented in the server (blocks 125, 127). These filtering rules are used to determine whether a received message falls into the “wanted,” and “unwanted,” or “preview” category. Thus, a particular message may be handled differently, depending upon whether it is received before or after a similar message that is previewed and identified by the user as a “wanted” or “unwanted” message. If the message and similar messages are to be deleted, It should be noted that the filtering implemented by the server to discriminate the different types of messages are caused by the client to be updated without having to send the actual filters from the client to the server. This can substantially reduce the amount of data that needs to be transmitted to cause the server-based filters to be updated by the client.

It should be noted that, while this embodiment provides a user with the four options for handling messages corresponding to the summary information (deliver one, deliver all, delete one, delete all), other embodiment may vary. For example, one alternative embodiment may provide the user with only the two delete options and the option to deliver the message corresponding to the preview information. That is, the user may elect to receive the entire message, delete only the message corresponding to the summary information, or delete the message and all of the messages that are similar to it. In this case, the user would not be able to identify messages similar to the current one as “wanted” messages that should always be delivered without previewing the summary information. Other variations are possible as well.

As noted above, one of the reasons that controlling delivery of e-mail messages is important is the prevalence of spam and similar types of unwanted messages. In the context of a desktop computing environment, these messages are an annoyance and a waste of both the resources of the computer and the time of the user. In extreme cases, unwanted e-mail may use enough resources to be a hindrance to efficient operation of the system. In the context of a mobile computing environment, the limited amount of resources that are available to begin with cause this unwanted e-mail to become a significant drain of resources. Moreover, because service providers typically charge users for delivery of messages (whether the messages are wanted or unwanted), large volumes of unwanted e-mail messages can incur substantial expense. By using feedback from the user as to what constitutes unwanted e-mail, embodiments of the present invention can substantially reduce both the drain on computing resources and that expense associated with delivery of the unwanted messages.

In one embodiment, the present system automatically accounts for billing issues associated with delivery of unwanted messages. That is, when a user identifies a message as unwanted and indicates that he does not want similar e-mails that are received in the future to be delivered, the system automatically credits his account for charges that may have been incurred in delivering the corresponding summary information. In this embodiment, the system is, of course, coupled to a billing system that is configured to track billable events associated with the delivery of messages (including the crediting of the user's account). Thus, the user does not have to spend the time or effort to independently contact the billing department of the service provider to request a credit for the delivery of the unwanted message.

It should be noted that, in this embodiment, the automatic crediting of the user's account is not initiated if the user indicates that only the particular message for which summary information was received and reviewed is to be deleted. This is a result of the balancing of two competing interests. The first of these interests is the user's desire not to be billed for unwanted messages. The second is the service providers desire not to have to automatically credit the user for messages which, although the user chose to delete them, the user still wishes to see at least the summary information. By tying the automatic credit mechanism to the designation of particular types of message as unwanted messages (that will simply be deleted in the future), the service provider has some assurance that the user is not simply trying to obtain free service by previewing messages and deleting them. If the message is truly unwanted (e.g., is spam), then the user most likely would not want to be bothered with it at all in the future.

As indicated above, the resources available to the e-mail client may be very limited. This includes the user interface through which a user provides feedback in response to previewing summary information for a message. For example, the client may be implemented in a cellular phone having a very small display for viewing the summary information and a simple keypad for data entry. Therefore, in one embodiment, the summary information comprises a small set of predefined data items, such as the originator and the subject line of the message, which can be displayed without much difficulty. The user feedback is also limited, and may comprise simply selecting a key corresponding to one of the four feedback options discussed above (view one, view all, delete one, delete all). If the user chooses to view or delete all similar messages, he may be provided with a limited number of options as to which information is used to identify “similar” messages. For example, “similar” messages may be identified based upon the sender, subject, or size of the message.

It should be noted that, while the user interactions described above are very simple as a result of limitations on the phone's physical interface, it is possible to define far more complex interactions (e.g., providing additional options or requesting textual input from the user). The interface may therefore vary in other embodiments.

In addition to the cellular phone interface (or other limited-resource interface), the user may be provided with additional access capabilities through other interfaces. For example, the user may be given authorization to access messages via an IP interface. For example, the user may access the messages from a home computer. The use of a less limited interface may also enable additional features, such as the ability for the user to access the filtering rules that are used by the e-mail server to determine which messages should be immediately delivered or deleted and which messages should be previewed. This may enable the user to view changes to the rules that are not immediately apparent through the limited-resource interface and to revise them if necessary.

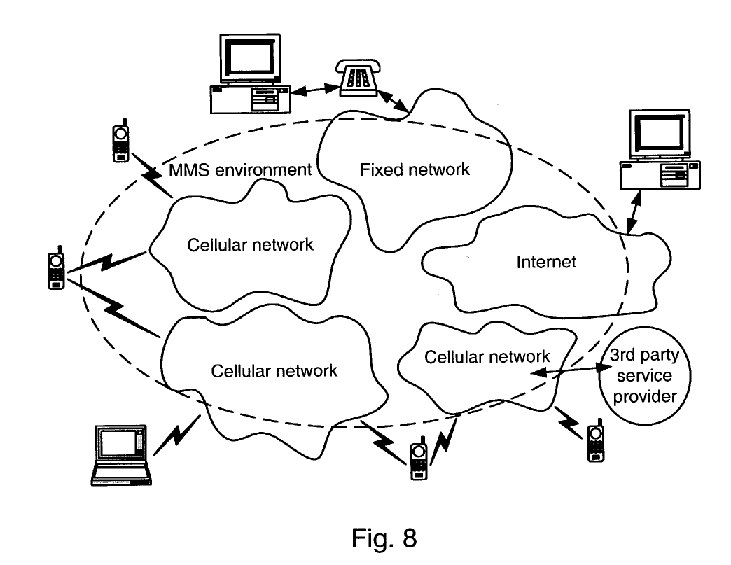

One embodiment of the present system is implemented in a Multimedia Messaging Service (MMS) environment. Referring to FIG. 8, a generalized view of the Multimedia Messaging Service architecture is shown. The MMS architecture is designed to combine different networks and network types, and to integrate messaging systems that already exist within these networks. The MMS environment provides all the necessary service elements for multimedia messaging and the present message delivery mechanism, such as delivery, storage and notification functionality. These service elements may be located within one network or distributed across several networks or network types.

As noted above, multimedia messaging may encompass many different network types. The connectivity between these different networks shall be provided by the Internet protocol and its associated set of messaging protocols. This approach enables MMS to be compatible with messaging systems found on the Internet.

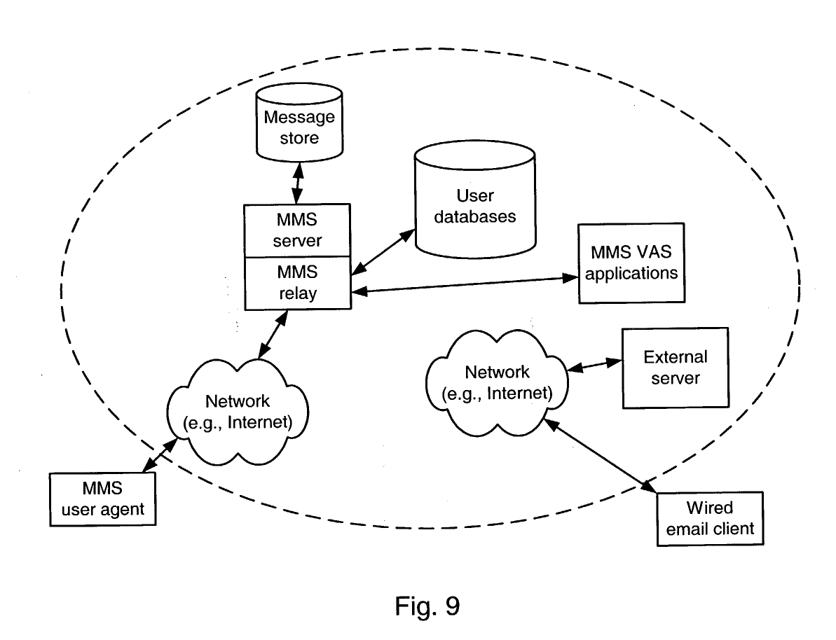

Referring to FIG. 9, a diagram illustrating the components of the MMS architecture is shown. The MMS architecture encompasses all the various elements that provide a complete MMS to a user (including internetworking between service providers). The MS environment is a collection of MMS-specific network elements under the control of a single administration. In the case of roaming, the visited network is considered a part of that user's MMS environment. Subscribers to another MMS service provider are considered to be a part of a separate MMS environment.

The MMS relay/server is responsible for storage and handling of incoming and outgoing messages and for the transfer of messages between different messaging systems. In one embodiment of the present invention, filtering functionality and the corresponding filtering rules would be embodied in the MMS relay/server. Depending on the business model, the MMS relay/server may be a single logical element or may be separated into MMS relay and MMS server elements. These may be distributed across different domains. The MMS relay/server should be able to generate charging data (a billing record) when receiving messages from or when delivering messages to another element of the MMS environment. The MMS relay/server should be able to generate charging data for value added service provider-related operations.

A MMS user agent resides on a mobile station or on an external device connected to a mobile station. The user agent is an application layer function that provides the users with the ability to view, compose and handle MS messages (e.g. submitting, receiving, deleting of messages). In one embodiment of the present invention, preview and feedback functionality would be embodied in the MMS user agent.

MMS user databases contain user related information, such as subscription and configuration information. MMS value added service applications offer value added services to MMS users. There could be several MMS value added service applications included in or connected to an MMS environment. MMS value added service applications may be able to generate billing records.

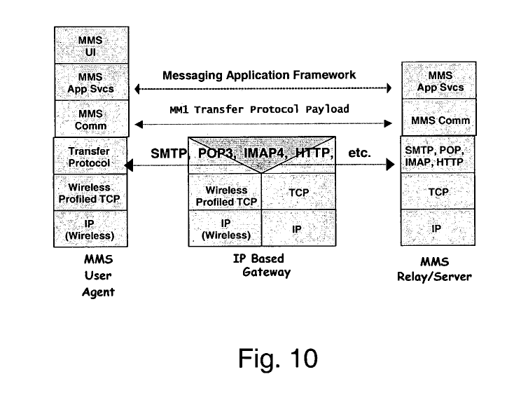

Referring to FIG. 10, a diagram illustrating the protocol framework definition for a Wireless Application Protocol (WAP)-based embodiment of the present invention is shown. In this embodiment, the preview and feedback functionality of the client is implemented in the MMS user interface (MS UI) of the user agent. WAP support for MMS is based upon the services of its supporting technology. It should be noted that the embodiment of FIG. 10 is exemplary, and other embodiments could, for instance, use protocols such as standard IETF protocols instead of WAP, or standard IETF mail protocols such as SMTP or IMAP instead of MMS or HTTP.

The link between the relay/server and the user agent has two links. The first, between the wireless MMS user agent and the WAP gateway, is where the “WAP stack” is used to provide a common set of services over a variety of wireless bearers. For application oriented services, like MMS and the preview and feedback of the present system, the interest is primarily in services offered by WAP Session Protocol (WSP). The second link connects the WAP gateway and the MMS relay/server. In the WAP architecture, the MMS Relay/Server is considered an origin server. These entities are connected over an IP network such as the Internet or a local intranet. HTTP is used for data transfer and data can be originated from either entity.

End-to-end connectivity, for the MMS application, between the wireless MMS user agent and the MMS relay/server is accomplished by sending data over WSP and HTTP. This is accomplished using the WSP/HTTP POST method for data originating at the wireless MMS user agent and by using the WAP Push Access Protocol in the other direction.

The various aspects and features of the present invention have been described above with regard to specific embodiments. As used herein, the terms ‘comprises,’ ‘comprising,’ or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

What is claimed is:

1. A method comprising:
receiving a plurality of messages;
identifying a first subset of the received messages; and
for each message in the first subset,
generating summary information,
providing the summary information to a client,
receiving feedback responsive to the summary information, and
handling the message in accordance with the feedback.

2. The method of claim 1, wherein the method comprises:
receiving the plurality of messages in an email server;
filtering the plurality of messages at the email server according to a set of filtering rules to identify a first subset of messages for which summary information is to be transmitted to the client, a second subset of messages which are to be transmitted to the client without first providing summary information to the client and a third subset of messages which are to be deleted without first providing any corresponding information to the client;
for messages in the first subset,
providing the summary information to the client,
receiving the feedback responsive to the summary information,
for messages which the feedback indicates should be delivered to the client, delivering the messages to the client,
for messages which the feedback indicates should be deleted, deleting the messages,
if the feedback indicates that future messages similar to a delivered message should be delivered without first providing summary information to the client, updating the set of filtering rules to indicate that future messages similar to the delivered message should be delivered without first providing summary information to the client, and
if the feedback indicates that future messages similar to a deleted message should be deleted without first providing summary information to the client, updating the set of filtering rules to indicate that future messages similar to the deleted message should be delivered without first providing summary information to the client and crediting the client for the deleted message;
for messages in the second subset, delivering the messages to the client without first providing summary information to the client; and
for messages in the third subset, deleting the messages without first providing summary information to the client.

3. The method of claim 1, wherein handling the message in accordance with the feedback comprises delivering the message to the client if the feedback indicates that the message should be delivered and deleting the message if the feedback indicates that the message should be deleted.

4. The method of claim 3, further comprising, if the feedback indicates that future messages similar to the message should be delivered without first providing summary information to the client, updating a set of filtering rules to indicate that future messages similar to the message should be delivered without first providing summary information to the client.

5. The method of claim 3, further comprising, if the feedback indicates that future messages similar to the message should be deleted without first providing summary information to the client, updating a set of filtering rules to indicate that future messages similar to the message should be deleted without first providing summary information to the client.

6. The method of claim 5, further comprising, if the feedback indicates that future messages similar to the message should be deleted without first providing summary information to the client, providing a credit to the client for delivery of the summary information.

7. The method of claim 1, further comprising identifying a second subset of the received messages, wherein each message in the second subset is delivered to the client without first providing summary information to the client.

8. The method of claim 1, further comprising identifying a third subset of the received messages, wherein each message in the third subset is deleted without first providing summary information to the client.

9. The method of claim 1, further comprising filtering the received messages according to a set of filtering rules to identify the first subset of the received messages and updating the filtering rules based upon feedback received from the client in response to summary information corresponding to messages in the first subset.

10. The method of claim 9, wherein the feedback comprises an indication that future messages similar to the message should be delivered to the client without first providing summary information to the client.

11. The method of claim 9, wherein the feedback comprises an indication that future messages similar to the message should be deleted without first providing summary information to the client.

12. The method of claim 9, wherein updating the filtering rules comprises identifying message characteristics associated with messages that are to be delivered to the client or deleted without first providing summary information to the client.

13. A system comprising:
a server; and
a client coupled to the server;
wherein the server is configured to
receive electronic messages addressed to the client,
apply dynamic filtering rules to the electronic messages,
transmit a summary information for a first subset of the filtered messages to the client,
receive feedback from the client responsive to the summary information, and
deliver or delete messages in the first subset according to the feedback.

14. The system of claim 13, wherein the server is further configured to modify the filtering rules based on the feedback.

15. The system of claim 13, wherein the server comprises a multimedia messaging relay/server.

16. The system of claim 13, wherein the client comprises a multimedia messaging user agent.

17. The system of claim 13, wherein the client is coupled to the server via a limited-bandwidth communication link.

18. The system of claim 17, wherein the limited-bandwidth communication link comprises a wireless communication link.

19. The system of claim 13, further comprising a billing system coupled to the server and configured to track billable events associated with delivery of messages.

20. The system of claim 19, wherein the server is configured to generate a billing record crediting an account associated with the client in response to receiving feedback indicating that an identified message and all similar messages are to be deleted without first being delivered to the client.

21. The system of claim 13, wherein the server is further configured to update a set of filtering rules to indicate that future messages similar to the message should be delivered without first providing summary information to the client if the feedback indicates that future messages similar to the message should be delivered without first providing summary information to the client.

22. The system of claim 13, wherein the server is further configured to update a set of filtering rules to indicate that future messages similar to the message should be deleted without first providing summary information to the client if the feedback indicates that future messages similar to the message should be deleted without first providing summary information to the client.

23. The system of claim 22, wherein the server is further configured to generate a billing record providing a credit to the client for delivery of the summary information if the feedback indicates that future messages similar to the message should be deleted without first providing summary information to the client.

24. The system of claim 13, wherein the server is further configured to identify a second subset of the received messages, wherein each message in the second subset is delivered to the client without first providing summary information to the client.

25. The system of claim 13, wherein the server is further configured to identify a third subset of the received messages, wherein each message in the third subset is deleted without first providing summary information to the client.

26. A software product comprising a plurality of instructions embodied in a medium readable by a data processor, wherein the instructions are configured to cause the data processor to perform the method comprising:
receiving a plurality of messages;
identifying a first subset of the received messages; and
for each message in the first subset,
generating summary information,
providing the summary information to a client,
receiving feedback responsive to the summary information, and
handling the message in accordance with the feedback.
